(19) United States
(12) Patent Application Publication
(10) Pub. No.: US 2009/0324098 A1
(43) Pub. Date: Dec. 31, 2009

(54) MOBILE PHONE WITH SELECTIVE PHOTOGRAPHIC SYSTEM AND METHOD

(75) Inventor: Peter Alexander NILSSON, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/147,704

(22) Filed: Jun. 27, 2008

(51) Int. Cl. G06K 9/62

(52) U.S. Cl. 382/209

(57) ABSTRACT

Electronic equipment, e.g., a mobile phone, includes a camera that continuously acquires a sequence of images that are stored on a FIFO basis, and a shutter release that identifies a current image. A number of images acquired sequentially before and after the current image and the current image are analyzed to select automatically a preferred image based on predetermined image attributes, e.g., open eyes, smile, image quality, etc. A method for storing images, selecting a sequence of images before, during and after shutter release, and selecting automatically from the sequence of images a preferred image based on image attributes. Software logic for carrying out the aforementioned method. A method for automatically adjusting a selected image based on attribute features from another image.

### TECHNICAL FIELD

The present invention relates generally to electronic equipment with a selective photographic system and method and, more particularly, to electronic equipment with a selective photographic system to select automatically a preferred photograph based on specified attributes, to a self-correcting photographic system, and to associated methods.

### BACKGROUND

Mobile and/or wireless electronic devices are becoming increasingly popular. For example, mobile telephones, portable media players and portable gaming devices are now in wide-spread use. In addition, the features and accessories associated with certain types of electronic devices have become increasingly diverse. To name a few examples, many electronic devices have cameras, text messaging capability, Internet browsing capability, electronic mail capability, video playback capability, audio playback capability, image display capability and hands free headset interfaces.

In an existing digital photographic system of a digital camera a sequence of images is captured continuously and stored in a buffer memory (also referred to as buffer) while the camera is on. As the buffer is filled with a predetermined number of images, the oldest image is erased to provide space for a new image in the stored sequence. Upon pressing the shutter release button (also referred to as shutter, shutter release, switch or trigger), the current image is stored in the buffer and subsequently a sequence of several additional images immediately following storing of the current image also is stored. For example, the total number of images stored in the buffer may be nine, including four images immediately preceding the current image and four images immediately following the current image. The user then may view the images stored in the buffer and may determine whether any of the images prior to or subsequent to the current image should be substituted for saving in the long term memory of the camera instead of the original current image. The user may take action to save the substitute image as the new current image, and the other images in the buffer may be discarded or eventually flushed from the buffer as new images are provided to replace them.

### SUMMARY

Briefly, an aspect of the present relates to automating the selecting of one or more images in the sequence of images that are stored prior to and/or subsequent to operating the shutter release. Image selection may be based on standard or previously set attributes on which the images in a sequence of images are characterized.

Another aspect relates to improving the characteristics of one or more images.

Briefly, in accordance with one aspect of the present invention electronic equipment includes a camera, and operating circuitry, including memory adapted to store a plurality of images sensed by the camera, and analyzer adapted to analyze respective images with respect to one or more attributes and to select automatically a preferred image based on matching with respect to one or more attributes.

According to another aspect the camera is adapted to provide images for storage in the memory, the camera includes a shutter release adapted to determine a current image, the memory is adapted to store a sequence of images including the current image and a number of the images provided by the camera prior to and subsequent to operating of the shutter release, and the analyzer is adapted to select automatically a preferred image from among the sequence of images stored in memory.

According to another aspect, the memory is adapted to save the preferred image.

According to another aspect, the operating circuitry is selectively operable to save as a preferred image an image that is different from the image that is selected automatically as a preferred image.

According to another aspect, the operating circuitry includes an input adapted to receive attributes determined by a user.

According to another aspect, a display is adapted to show images from the camera and/or from the memory.

According to another aspect, the camera is adapted to provide a sequence of images and the operating circuitry continuously stores images in memory and erases images from memory on a first in first out basis.

According to another aspect, the operating circuitry further is adapted to select an attribute feature of an image to be corrected or changed, to obtain such attribute feature from another image, and to adjust the first-mentioned image using such attribute feature from such another image.

According to another aspect, the electronic equipment is a mobile telephone.

According to another aspect a photography method includes acquiring a sequence of images, analyzing automatically images in the sequence of images to determine relative matching to one or more attributes, and selecting automatically a preferred image based on relative matching with respect to one or more attributes.

According to another aspect the sequence of images is stored in memory, a shutter release is operated to determine a current image, and the storing includes storing a sequence of images including the current image and a number of the images prior to and subsequent to operating of the shutter release, and the selecting includes selecting automatically a preferred image from among the sequence of images stored in memory.

According to another aspect, the storing the sequence of images includes storing in and erasing from memory images on a first in/first out basis.

According to another aspect, the method includes saving the preferred image.

According to another aspect, the method includes saving as a preferred image an image that is different from the image that is selected automatically as a preferred image.

According to another aspect, the method includes determining the one or more attributes.

According to another aspect, the method includes displaying the preferred image.

According to another aspect, the method includes selecting an attribute feature of an image to be corrected or changed, obtaining such attribute feature from another image, and adjusting the first-mentioned image using such attribute feature from such another image.

According to another aspect, the steps are carried out in a mobile communication device.

According to another aspect, computer software includes program logic to carry out one or more of the above steps.

According to another aspect, a method of correcting or adjusting an image includes selecting an image from among a number of images based on matching of attributes, selecting an attribute feature of the selected image to be corrected or adjusted, obtaining such attribute feature from another image, and adjusting the selected image using such obtained attribute from such another image.

According to another aspect, the obtaining includes cutting the attribute feature from such another image, and the adjusting comprising pasting such cut attribute feature into the selected image.

According to another aspect, the adjusting includes substituting the obtained attribute feature from such another image for the corresponding attribute feature in the selected image.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

In the annexed drawings:

FIG. 1 is a schematic isometric illustration of a portable electronic device, e.g., in the form of a mobile phone;

FIG. 2 is a schematic side elevation view of the mobile phone of FIG. 1;

FIG. 3 is a schematic system diagram of circuitry and associated parts of the mobile phone for carrying out operation thereof in a manner described below;

FIG. 4 is a schematic flow chart diagram illustrating exemplary logic according to which images may be stored, analyzed, and shown or saved;

FIG. 5 is a schematic flow chart diagram illustrating further details of exemplary logic according to which images may be stored, analyzed, and shown or saved; and

FIG. 6 is a schematic flow chart diagram illustrating exemplary logic for modifying images.

### DESCRIPTION

The interchangeable terms “electronic equipment” and “electronic device” include portable radio communication equipment. The term “portable radio communication equipment,” which hereinafter is referred to as a “mobile radio terminal,” as “portable electronic equipment,” or as a “portable communication device,” includes all equipment such as mobile telephones, pagers, communicators, electronic organizers, personal digital assistants (PDAs), smartphones, portable communication apparatus or the like.

In the present application, embodiments of the invention are described primarily in the context of a portable electronic device in the form of a mobile telephone (also referred to as “mobile phone”). However, it will be appreciated that the invention is not intended to be limited to the context of a mobile telephone and may relate to any type of appropriate electronic equipment, examples of which include a media player, a gaming device, PDA and a computer, digital cameras, etc.

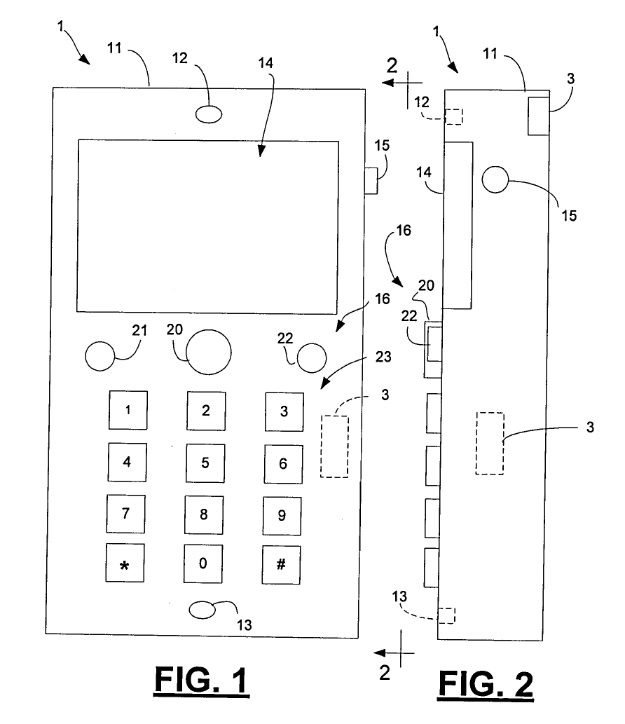

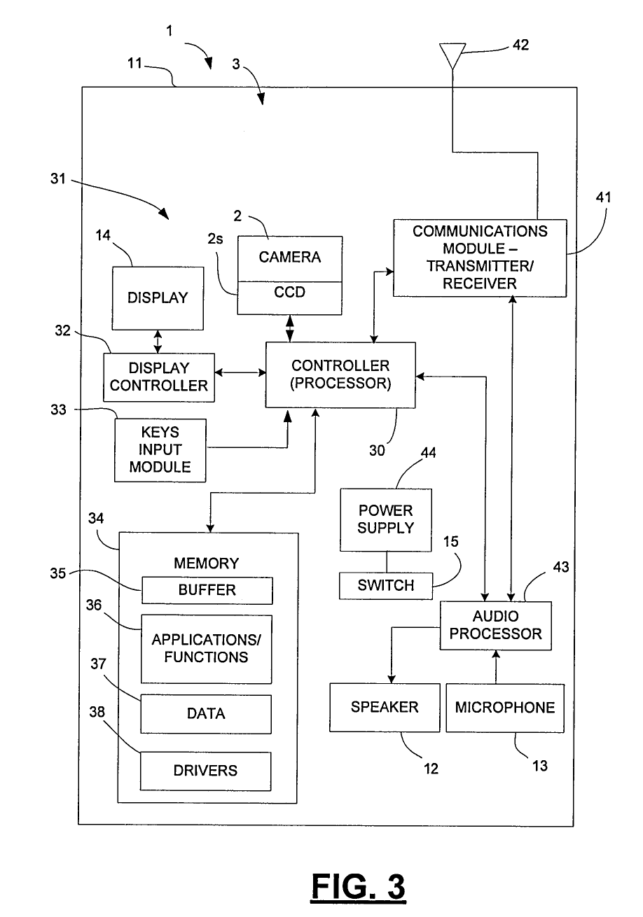

Referring in detail to the drawings, and initially to FIGS. 1-3, a portable communication device in accordance with an embodiment of the present invention is illustrated generally at 1 including a camera 2 and operating circuitry 3. The portable communication device 1 will be referred to below as a mobile phone. However, as was mentioned above, reference to “mobile phone” includes various other devices, such as, for example, those mentioned above. In outward appearance, for example, as is illustrated in FIGS. 1 and 2, the mobile phone 1 is of one type of design or style; however, the features of the invention, as are described in further detail below, may be used in other types of mobile phones, such as those that include cases that open and close (sometimes referred to as a “flip phone,” “sliding phones,” etc.), and various other mobile phones that currently exist or may come into existence in the future.

The portable electronic device 1 may be any of many different types of such devices. As a mobile phone 1, for example, the portable electronic device includes case (housing) 11, speaker 12, microphone 13, display 14, e.g., liquid crystal display, light emitting diode display, or other display, on/off switch 15, and a number of keys generally indicated at 16. The keys 16 may include a number of keys having different respective functions. For example, the key 20 may be a navigation key, selection key or some other type of key; the keys 21, 22 may be, for example, one or more soft switches or soft keys; and the keys 23 may be dialing keys. As an example, the navigation key 20 may be used to scroll through lists shown on the display 14, to select one or more items shown in a list on the display 14, etc. The soft switches 21, 22 may be manually operated to carry out respective functions, such as those shown or listed on the display 14 in proximity to the respective soft switch or selected by the navigation key 20, etc. The display 14 may include a GUI on which a number of different icons representing respective functions, applications or the like (collectively referred to as functions below), e.g., camera, email, calendar, contacts, messages, games, etc., and the navigation key 20 may be used to point to a given function, application, etc., and either the navigation key and/or the soft keys, for example, may be used to select the function to cause it to carry out its task or the like. If the display 14 is a touch sensitive display, the pressing of an icon also can select the given function or application represented by the touched icon. The soft keys 21, 22 may be used to initiate a phone call, e.g., to connect to a wireless telephone circuit and to transmit a telephone number, etc., to answer an incoming phone call, to take a photograph (e.g., to provide a shutter release function to store electronically an image received by the camera 2 lens, to transmit a text message, etc., to end a phone call, and/or to carry out other functions.

The dialing keys 23 may be used to dial a telephone number or to input alphanumeric or other data. The speaker 12, microphone 13, display 14, and keys 16 may be used and function in the usual ways in which a mobile phone typically is used, e.g. to initiate, to receive and/or to answer telephone calls, to send, to receive and to review text messages and email, to connect with and carry out various functions via a network, such as the Internet or some other network, to beam or otherwise to transfer information between mobile phones, etc. These are examples; there may be other uses that currently exist or may exist in the future. The mobile phone 1 also includes operating circuitry 3 (schematically illustrated in FIG. 1 and shown in further detail in FIG. 3) that responds to programming and to inputs, e.g., provided by a user pressing a key or applying a stylus or finger to a touch-sensitive screen of the display 14, etc. or provided from an external source, such as an incoming telephone call or text message, to carry out functions of the mobile phone.

Briefly turning to FIG. 3, a schematic block diagram of the operating circuitry or system 3 of the mobile phone 1 is illustrated. The illustration is exemplary; other types of circuitry may be employed in addition to or instead of the operating circuitry 3 to carry out the camera or photographic functions described in further detail below, the various telecommunication and other functions of a mobile phone. The operating circuitry 3 includes a controller 30 (sometimes referred to as a processor or as an operational control and may include a microprocessor or other processor device and/or logic device) that receives inputs and controls the various parts and operation of the operating circuitry. An input module 31 provides inputs to the controller 30. The input module includes the camera 2, a display controller 32, and a keys input module 33.

The camera 2 may include a lens, shutter, image sensor 2s, e.g., a digital image sensor, such as, for example, a CCD (charge coupled device), a CMOS device, or another image sensor. Images that are sensed by the image sensor may be provided the controller 30 for use in the manner described further below. The camera 2 also may be associated with a shutter release mechanism, one example of which is the navigation key that may function to in a sense “take a picture” when it is pressed by a user while the mobile phone 1 is operating in a photographic mode (sometimes referred to as camera mode). As is described in further detail below, pressing the shutter release button (e.g., the navigation key 20, a soft key 21 or 22, an icon shown on the display 14, or some other key (shown or not shown in the drawings) when the mobile phone 1 is in camera mode) would save in a buffer, for example, the current image being sensed by the image sensor.

The display controller 32 responds to inputs from a touch sensitive display 14 or from another type of display that is capable of providing inputs to the controller. Thus, for example, touching of a stylus or a finger to a part of a touch sensitive display, e.g., to select a song in a displayed list of songs, to select a contact in a displayed list of contacts, to select an icon or function in a GUI shown on the display may provide an input to the controller in conventional manner. The display controller 32 also may receive inputs from the controller 30 to cause images, icons, information, etc., to be shown on the display 14. The keys input module 33, for example, may be the keys 16 themselves and/or may be signal conditioning, decoding or other appropriate circuitry to provide to the controller 30 information indicating the operating of one or more keys 16 in conventional manner.

A memory 34 is coupled to the controller 30. The memory may be a solid state memory, e.g., read only memory (ROM), random access memory (RAM), SIM card, etc., or memory that maintains information even when power is off and that can be selectively erased and provided with more data, an example of which sometimes is referred to as an EPROM or the like. The memory may be some other type device. The memory 34 includes a buffer memory 35 (sometimes referred to herein as buffer). The memory 34 may include an applications or functions storing section or function 36 to store applications programs and functions programs or routines for carrying out operation of the mobile phone 1 via the controller 30. The memory 34 also may include a data storage section or function 37 to store data, e.g., contacts, numerical data, pictures, and/or virtually any other data for use by the mobile phone 1. A drivers section 38 of the memory 34 may include various drivers for the mobile phone 1, for communication functions and/or for carrying out other functions of the mobile phone.

As is described further below, the buffer 35 may be used to save photographs from the camera 2 and/or for other purposes. The buffer 35 may be a part of the memory 34, e.g., specified address locations in a memory device, or part of the data storage section 37, etc., may be a separate memory device in the mobile phone 1, or may be otherwise provided to carry out the functions described further below.

The mobile phone 1 includes a telecommunications portion 40. The telecommunications portion 40 includes, for example, a communications module—transmitter/receiver 41 that receives incoming signals and transmits outgoing signals via antenna 42. The communications module—transmitter/receiver 41 is coupled to the controller 30 to provide inputs to and to receive output signals, as may be the case in conventional mobile phones. The communications module—transmitter/receiver 41 also is coupled to the speaker 12 and microphone 13 via an audio processor 43 to provide audio output via the speaker and to receive audio input from the microphone for usual telecommunications functions. The speaker 18 and microphone 20 enable a user to listen and to speak via the mobile phone 1. Audio data may be passed to the audio processor 43 from the memory 34 via the controller for playback to the user. The audio data may include, for example, audio data from an audio file stored in the memory 34 and retrieved by the controller 30. The audio processor 43 may include any appropriate buffers, decoders, amplifiers and the like.

The mobile phone 1 also includes a power supply 44 that may be coupled to provide electrical power to the operational circuitry 3 upon closing of the on/off switch 15.

For telecommunication functions and/or for various other applications and/or functions as may be selected from a GUI, the mobile phone 1 may operate in a conventional way. For example, the mobile phone may be used to make and to receive telephone calls, to play back songs, pictures, videos, movies, etc., to take and to store photographs or video, to prepare, to save, to maintain, and to display documents and databases such as a contacts or other database, to browse the Internet, to maintain a calendar, etc.

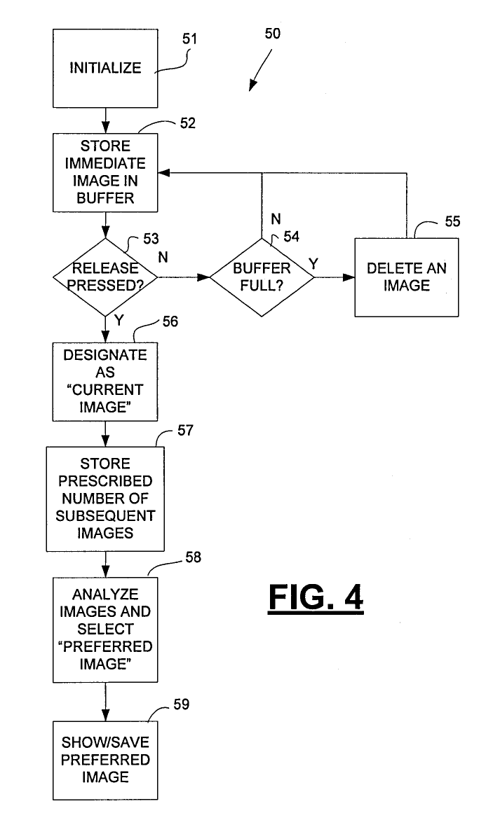

FIG. 4 illustrates a schematic flow chart or logic diagram 50 representing a photography or photographic operation of the mobile phone 1 in camera mode, e.g., the camera 2 is operational to obtain or to acquire images. At block 51 the camera 2 is initialized, e.g., turned on, so that images received by the image sensor can be received and provided to the controller 30 for storage and/or saving in the memory 34. Summarizing camera 2 operation in conjunction with the operating circuitry 3, as is described in further detail below, the camera continuously or at least periodically provides a plurality of images, e.g., a sequence of images, for storage in the memory 34 both before and after a shutter release key is pressed or some other shutter release function is effected (hereinafter collectively referred to as “release pressed” for brevity). When the release is pressed, the image then sensed by the image sensor is designated as the “current image.” The current image is stored as are a number of images in the sequence of images prior to and after the current image. The stored images are analyzed in a manner described further below, and a preferred image is selected to be shown on the display 14 and/or to be saved in long term memory, e.g., data memory section 37, of the memory 34.

Continuing to refer to FIG. 4, at block 52 the image sensed by the image sensor (FIG. 3) is stored in the buffer 35 as the “immediate image.” At block 53 an inquiry is made whether the release is pressed. If the release is not pressed, then at block 54 an inquiry is made whether the buffer 35 is full, e.g., is the maximum number of images stored in the buffer. As an example, the controller 30 may be programmed or set up to store the current image and a prescribed number of images prior to the current image and a prescribed number of images subsequent to the current image. The number of prior images may be the same or different from the number of subsequent images. An exemplary total number of images may be nine images, including four images prior to the current image, the current image, and four images subsequent to the current image. The number of prior and/or subsequent prescribed images may be other than four. Also, if desired, the operational control 3 may be set up so that only prior images or only subsequent images are stored.

At block 54, if the buffer 35 is not full, then the flow chart reverts to block 52 and the next image in the sequence of images is stored in the image buffer. At block 53 an inquiry is made again whether the release has been pressed. This just described loop including blocks 52, 53 and 54 may continue until the buffer has been fully populated with the intended number of images in the stored sequence of images.

If at block 53 the shutter release has been detected prior to the buffer 35 having been fully populated, then the flow chart may go to block 56 without having fully populated the buffer. Other possible procedures also may be followed such as, for example, to designate the current image upon pressing the shutter release and still populating some of the prior image locations with subsequent images stored after the current image had been stored and so designated. These are only examples; other procedures also may be used as determined, for example, by a person who has ordinary skill in the art.

If the inquiry at block 54 determines that the buffer 35 is full, e.g., is fully populated with the intended number of images in the stored sequence of images, then at block 55 an image is deleted from the buffer, and the flow chart returns to block 52. The images may be stored and erased from the buffer 35 on a first in/first out basis or on some other basis. The image deleted at block 55 may be the first image in the sequence to make room for the next image.

If the inquiry at block 53 determines that the shutter release has been pressed, then at block 56 the image then being sensed by the image sensor 2s is designated as the current image. At block 57 the buffer 35 is populated sequentially with the prescribed number of subsequent images in a manner similar to that represented by blocks 52, 54 and 55. For example, the first (oldest in time) image in the buffer is deleted and the first subsequent image is stored; and this process is repeated until the prescribed number of subsequent images is stored in the buffer along with the prescribed number of prior images and the current image.

At block 58, which may represent an analyzer and/or comparator device and function and also may include a selection (or selector) device or function, the current image and the prior and subsequent images stored in the buffer 35 are analyzed, and a preferred image is selected. The preferred image may be a single image or it may be more than one image. The analysis of the images may be based on attributes of the images, as will be described further below. Several examples are described here; there may be other attributes. If the image is of a single person, one or more of the attributes may be whether the person's eyes are open or closed and, if desired, how wide open, whether smiling or not and, if desired, how broad is the smile (is the mouth open in a wide smile or partly or fully closed in a narrower smile), whether looking toward the camera or elsewhere, whether the entire face is shown or part is cut off in the image, etc. Other attributes may be precision of focus, desirable contrast, alignment (e.g., is the image squared or otherwise suitably aligned with the top, side(s) and/or bottom of the frame outlining the image, etc. Similar attributes may be used for images with a group of persons: for example, how many of the persons have their eyes open, how many of the persons are smiling, are any individuals cut off in the image, etc.

The comparisons made of the images can be carried out by computer software or the like. Examples of such software are commercially available, such as, face recognition software and image analysis software. Additionally, if desired, a person who has ordinary skill in the art of image processing, analysis and selection would be able in a reasonable period of time to write appropriate software to carry out the analysis, e.g., the comparisons and selections described herein.

Based on the analysis of the sequential images, the computer software may select a preferred image, e.g., one that most closely matches the desired attribute or several attributes. The attributes may be weighted, for example, to give a higher score (or a score, ranking, rating likely to closely match the desired attributes or relative matching or closeness of matching to the desired attributes) to whether eyes are open than to whether the face of the individual or individuals is/are smiling, as may be desired. Furthermore, as is described further below, the attributes may be standard ones that are stored in the mobile phone 1 by the manufacturer and/or they may be input by a user of the mobile phone.

At block 59 the image selected by the operating circuitry 3, e.g., as was described above, may be shown on the display 14 and/or may be saved in the 34, e.g., for relatively long term storage and subsequent retrieval, copying, transmission via the communications module 41, etc. If desired, the sequence of images on which the analysis has been made also may be reviewed by the user. For example, the user may be able to scroll through the sequence of images and may make a personal determination to substitute a different image for the one to be saved rather than the preferred image that had been selected by the operating circuitry 3 in the manner described above or some other manner. Many digital cameras and cameras associated with mobile phones have the ability to scroll through images and to select images; and such scrolling and selecting may be carried out by the user to view the several images stored in the buffer 35 and to select one or more preferred image(s) for long term storage in the memory 34.

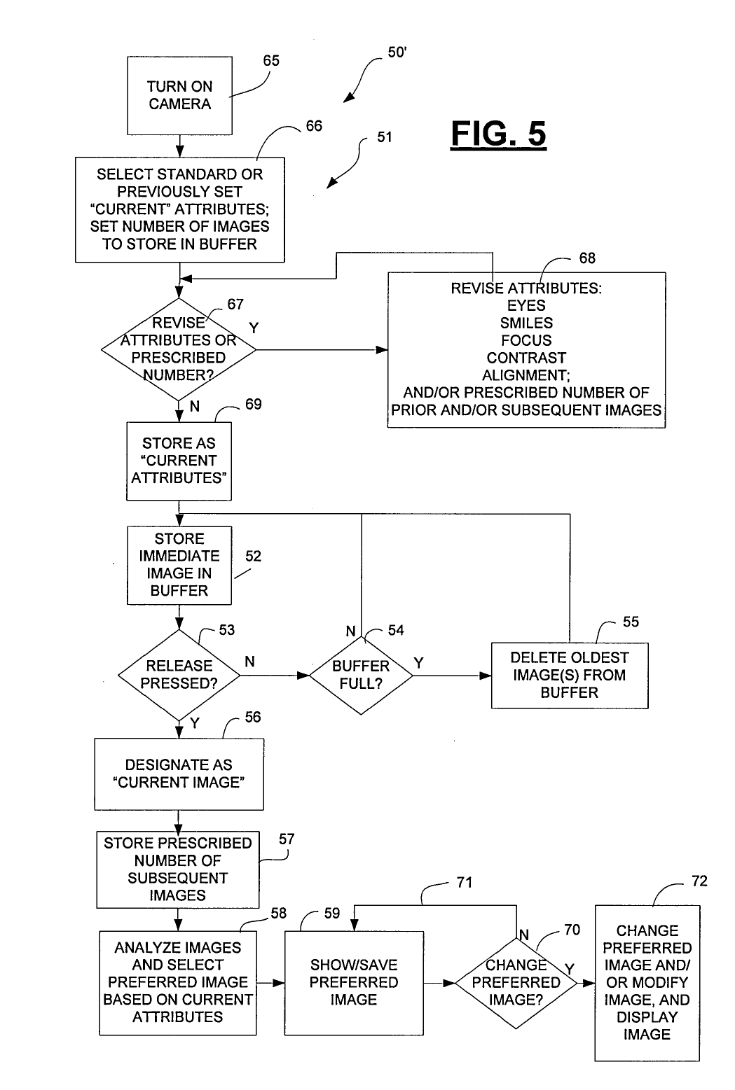

Referring to FIG. 5, a flow chart 50′, which is similar to the flow chart 50 of FIG. 4, illustrates logic and a method of carrying out the invention. The initializing steps 51 are shown as, for example, turn on the camera 2 at block 65, set attributes at block 66, possibly revise attributes at blocks 67 and 68, and store the attributes at block 69. As was mentioned above, various attributes (sometimes also referred to as features of an image or characteristics of the image) may be used to determine a preferred image that is selected and stored and/or shown to a user. At block 66 standard or previously set “current” attributes may be set. For example, the standard attributes may have been previously set or stored in the mobile phone 1 by the manufacturer; or the attributes may have been previously set by the user when previously using the mobile phone. The attributes may be among several different groupings, e.g., a group of attributes that prefers smiling faces and open eyes; a group of attributes that requires serious faces and open eyes; a group of attributes that requires sharp focus of the primary image and blurring of background as in a camera setting that has a relatively short depth of field, etc. The user may select one of those groups or may select standard attributes or may select only specified attributes. It is intended that the sequence of images would be compared with those attributes to select a preferred image.

Another setting that may be adjusted and/or set at block 66 is the number of images to store in the buffer 35. For example, this feature may permit the user to determine how many prior and subsequent images would be stored in the buffer for use in determining a preferred image.

As was mentioned above, pressing the shutter release determines that the immediate image being sensed by the image sensor 2s is the “current image” and based on which is the current image, the prescribed number of prior and subsequent images that are stored in the buffer 35 are used for use in making the comparison of how closely respective images match the selected or “current” attributes by a ranking or otherwise, thereby to determine the preferred image.

After determining the current attributes and/or number of images to store in the buffer, an inquiry is made at block 67 whether to revise the attributes and/or the prescribed number of prior or subsequent images. If the answer is yes, then at block 68 the attributes can be revised by the user. For example, the user may indicate that the attributes should be open eyes or number of open eyes in a group photograph; or the attributes should be the number of smiling faces or serious faces in a group photograph, etc. The prescribed number also may be selected.

Currently computer software or image analysis software and algorithms are available to determine whether eyes are open, mouths or faces are smiling, etc. Such software may include process that make decisions based on comparison of a given image with a database of many images. In such case, the images in the database that have open eyes may be selected for comparison with the given image that has been obtained from the image sensor 2s; similarly, an image database having a number of serious looking faces or having a number of smiling faces, etc., may be used for comparison with the image(s) obtained from the image sensor 2s and stored in the buffer 35. The computer software used to determine whether the images from the image sensor 2s and stored in the buffer 35 may be based on algorithms that measure relationships between the dimensions of eyes, mouths, etc. and/or on location of the pupil of the eye relative to the eye socket, etc. The attributes may be based on sharpness of images to determine in focus images or based on a comparison of sharp portions of the image and fuzzy (non-sharp) portions of the image to determine depth of field and images with so-called halo effects, etc. These are just a few examples of attributes and how they may be used in selecting automatically a preferred image from a sequence of images.

At block 67, if attributes and/or prescribed number of prior and/or subsequent images are not to be revised, e.g., they simply are not to be revised or they have been revised satisfactorily at block 68, then at block 69 the attributes number are stored as “current attributes.” Also, the prescribed number(s) of prior and subsequent images mentioned above also is set (or had not been changed).

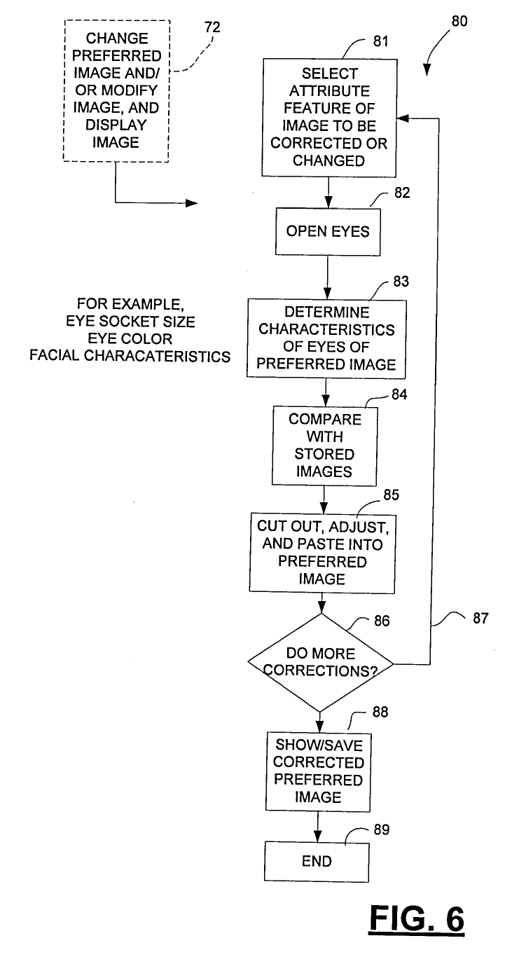

The steps at blocks 52, 53, 54, 55, 56, 57, 58 and 59 are the same or substantially the same as were described above with respect to similarly numbered blocks in FIG. 4. However, at block 70 an inquiry may be made to inquire whether there is a desire to change the preferred image that was selected automatically according to the steps described above. If the answer is no, then the preferred image continues to be displayed as a loop 71 continues to be followed or the routine ends leaving the current preferred image shown on the display and/or automatically saved in the long term portion of the memory 34, e.g., at the data portion 37 of the memory 34, as was described above. If the answer at inquiry block 70 is yes, then at block 71 the user may change the preferred image and/or modify the image and may display the different preferred image or modified image. Modification of the preferred image is described below with respect to FIG. 6.

In FIG. 6 a flow chart 80 illustrates an example of computer program software and logic that may be used to correct or to adjust an image, e.g., as is referenced initially at block 72 (shown in FIG. 5 and also shown in dotted outline in FIG. 6). The correction or adjustment logic 80 may be used for various reasons. One example is a circumstance in which a preferred image that was automatically selected, e.g., as was described above, or was manually selected by a user, has an undesirable attribute, such as one or both eyes of an individual are closed, whereas it is desired that the eyes be open. Other characteristics may be a blemish on the skin of the person, a frown, a sneer, etc.

According to the logic steps illustrated at 80 in FIG. 6, at block 81 the attribute or feature of the image that is to be corrected or changed, e.g., adjusted or switched in some manner, is selected. At block 82 the exemplary attribute is “open eyes.” For example, at least one eye of at least one person (or other animal) is closed or partly closed, and it is desired to show that eye open.

At block 83 characteristics of the eye(s) that are in the preferred image that is to be corrected or changed are determined. For example, a measurement is taken of the size of the eye in the image or the size of the eye socket. For example, the width of the eye socket and the height of the eye socket; the apparent roundness (or ellipsoid shape) of the eye socket may be measured. The measurements may be in proportion to other size characteristics of the face in which the eye is located. Another characteristic of the eye may be color of the eye. The color of the eye may be determined, for example, if the other eye of the person in the image being changed is open, by checking the color of the open eye. Color may be determined from one of the eyes shown in one of the prior or subsequent images of the person that were stored in the buffer 35 during the steps to determine a preferred image. Placement of the eye and orientation of the eye socket and possibly other dimensional and/or other facial characteristics of the face in which the eye is located also may be determined.

At block 84 a comparison is made with a number of stored images in a database of images saved in the memory 34 or provided from an outside source of images to find an eye that meets the attributes, e.g., open eye, and also has characteristics of the eye that is to be replaced in the image be corrected or changed. The mentioned database of images may include images of faces of other persons; and/or the database of images of showing the face of the person in the image being corrected or changed. For example, in the latter case, the database of images may include one or more of the prior and/or subsequent images relative to the “current image” as described above. The database may include more than the prescribed number of images, such as, for example, images of the person that were obtained and stored in another buffer or in long term memory of images. Thus, it will be appreciated that the database of images may include images from various sources.

As part of the comparison made at block 84, an image is selected for use in correcting or changing the preferred image that is to be adjusted. Then, at block 85 the appropriate part of the selected image from the database of images is cut out to be pasted into the image of the preferred image that is to be corrected or changed. In the instant example, the eye of the face selected from the database of images may be cut out and pasted into the preferred image, thus effecting the desired correction or change to the preferred image.

At block 86 an inquiry is made as to whether more corrections are to be done. If yes, then loop 87 is followed back to block 81, and the above steps 81-86 may be carried out. If no more corrections are to be done, then at inquiry block 86 the logic diagram moves to block 88, and the corrected or changed image is shown on the display 14 and/or is saved in the memory 34 for subsequent use. At block 89 the logic functions end. The preferred image, then, has improved correspondence to the attributes that were selected for the preferred image to have when the method described above was initiated. It will be appreciated that various steps, routines, subroutines, etc. described above may be repeated to obtain a desired preferred image that has improved characteristics matching the attributes for the image.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. Electronic equipment, comprising
a camera, and
operating circuitry, including
memory adapted to store a plurality of images sensed by the camera, and
analyzer adapted to analyze respective images with respect to one or more attributes and to select automatically a preferred image based on matching with respect to one or more attributes.

2. The electronic equipment of claim 1, wherein the camera is adapted to provide images for storage in the memory, the camera includes a shutter release adapted to determine a current image, the memory is adapted to store a sequence of images including the current image and a number of the images provided by the camera prior to and subsequent to operating of the shutter release, and the analyzer is adapted to select automatically a preferred image from among the sequence of images stored in memory.

3. The electronic equipment of claim 1, wherein the memory is adapted to save the preferred image.

4. The electronic equipment of claim 1, wherein the operating circuitry is selectively operable to save as a preferred image an image that is different from the image that is selected automatically as a preferred image.

5. The electronic equipment of claim 1, wherein the operating circuitry includes an input adapted to receive attributes determined by a user.

6. The electronic equipment of claim 1, further comprising a display adapted to show images from the camera and/or from the memory.

7. The electronic equipment of claim 1, wherein the camera is adapted to provide a sequence of images and the operating circuitry continuously stores images in memory and erases images from memory on a first in first out basis.

8. The electronic equipment of claim 1, wherein the operating circuitry further is adapted to select an attribute feature of an image to be corrected or changed, to obtain such attribute feature from another image, and to adjust the first-mentioned image using such attribute feature from such another image.

9. The electronic equipment of claim 1, comprising a mobile telephone.

10. A photography method, comprising
acquiring a sequence of images,
analyzing automatically images in the sequence of images to determine relative matching to one or more attributes, and
selecting automatically a preferred image based on relative matching with respect to one or more attributes.

11. The method of claim 10, comprising storing the sequence of images in memory, operating a shutter release to determine a current image, said storing comprising storing a sequence of images including the current image and a number of the images prior to and subsequent to operating of the shutter release, and said selecting comprising selecting automatically a preferred image from among the sequence of images stored in memory.

12. The method of claim 11, said storing the sequence of images comprising storing in and erasing from memory images on a first in/first out basis.

13. The method of claim 10, comprising saving the preferred image.

14. The method of claim 10, comprising saving as a preferred image an image that is different from the image that is selected automatically as a preferred image.

15. The method of claim 10, comprising determining the one or more attributes.

16. The method of claim 10, further comprising displaying the preferred image.

17. The method of claim 10, further comprising selecting an attribute feature of an image to be corrected or changed, obtaining such attribute feature from another image, and adjusting the first-mentioned image using such attribute feature from such another image.

18. The method of claim 10, comprising carrying out the steps in a mobile communication device.

19. Computer software comprising program logic to carry out the steps of claim 10.

20. A method of correcting or adjusting an image, comprising
selecting an image from among a number of images based on matching of attributes,
selecting an attribute feature of the selected image to be corrected or adjusted,
obtaining such attribute feature from another image, and
adjusting the selected image using such obtained attribute from such another image.

21. The method of claim 20, said obtaining comprising cutting the attribute feature from such another image, and said adjusting comprising pasting such cut attribute feature into the selected image.

22. The method of claim 20, said adjusting comprising substituting the obtained attribute feature from such another image for the corresponding attribute feature in the selected image.
